(19) United States
(12) Patent Application Publication
(10) Pub. No.: US 2026/0120649 A1
(43) Pub. Date: Apr. 30, 2026

(54) GATE DRIVER AND DISPLAY DEVICE INCLUDING THE SAME

(71) Applicant: LG Display Co., Ltd., Seoul (KR)

(72) Inventor: Boo Heung Lee, Paju-si (KR)

(21) Appl. No.: 19/346,426

(22) Filed: Sep. 30, 2025

(30) Foreign Application Priority Data
Oct. 31, 2024 (KR) 10-2024-0151664

(51) Int. Cl. G09G 3/3266; G09G 3/3233

(52) U.S. Cl. CPC G09G 3/3266; G09G 3/3233; G09G 2300/0819; G09G 2300/0842; G09G 2300/0861; G09G 2310/0286; G09G 2310/08

(57) ABSTRACT

A gate driver of a display device includes a plurality of signal transmission parts that are connected in cascade via a carry line to which a carry signal is applied from a preceding signal transmission part and that are configured to output a gate signal according to a clock signal, wherein each signal transmission part includes: a first output circuit configured to receive a first carry signal from the preceding signal transmission part and output a second carry signal based on the first carry signal and the clock signal; a selection circuit configured to receive the second carry signal from the first output circuit and selectively output the second carry signal based on a voltage level of a selection data voltage; and a second output circuit configured to output a gate signal based on (i) the selectively transmitted second carry signal from the selection circuit and (ii) another clock signal.

### CROSS-REFERENCE TO RELATED APPLICATION

Pursuant to 35 U.S.C. § 119(a), this application claims the benefit of an earlier filing date and right of priority to Korean Patent Application No. 10-2024-0151664, filed Oct. 31, 2024, the disclosure of which is incorporated herein by reference in its entirety.

### TECHNICAL FIELD

The present disclosure relates to a gate driver and a display device including the same.

### BACKGROUND

Electroluminescent display devices include inorganic light emitting display devices and organic light emitting display devices, which differ according to a material of a light emitting layer. An active-matrix type organic light emitting display device includes an organic light emitting diode (hereinafter referred to as an “OLED”) which emits light by itself, and has advantages in fast response speed and greater luminous efficiency, luminance, and a viewing angle.

In organic light-emitting display devices, OLEDs are formed in each of pixels. Such organic light display devices not only respond quickly and have excellent light-emitting efficiency, luminance, and viewing angle, but also have excellent contrast ratio and color reproduction rate because they can express black tones as complete black.

### SUMMARY

A gate driver according to implementations of the present disclosure may include a plurality of signal transmission parts that are connected in cascade via a carry line to which a carry signal is applied from a preceding signal transmission part and that are configured to output a gate signal according to a clock signal, wherein each signal transmission part includes: a first output circuit configured to receive a first carry signal from the preceding signal transmission part and output a second carry signal based on the first carry signal and the clock signal; a selection circuit configured to receive the second carry signal from the first output circuit and selectively output the second carry signal based on a voltage level of a selection data voltage; and a second output circuit configured to output a gate signal based on (i) the selectively transmitted second carry signal from the selection circuit and (ii) another clock signal.

A display device according to implementations of the present disclosure may include a pixel array in which a plurality of data lines, a plurality of gate lines, and a plurality of pixel circuits are arranged; a data driver configured to output a data voltage to the plurality of data lines; and a gate driver configured to output a gate signal to the plurality of gate lines, wherein the gate driver includes a plurality of signal transmission parts that are connected in cascade via a carry line to which a carry signal is applied from a preceding signal transmission part and that are configured to output a gate signal according to a clock signal, wherein each signal transmission part includes: a first output circuit configured to receive a first carry signal from the preceding signal transmission part and output a second carry signal based on the first carry signal and the clock signal; a selection circuit configured to receive the second carry signal from the first output circuit and selectively output the second carry signal based on a voltage level of a selection data voltage; and a second output circuit configured to output a gate signal based on (i) the selectively transmitted second carry signal from the selection circuit and (ii) another clock signal.

### BRIEF DESCRIPTION OF THE DRAWINGS

FIG. 1 is a block diagram illustrating an example of a display device according to an implementation of the present disclosure;

FIG. 2 is a diagram illustrating an example of a pixel circuit according to the implementation of the present disclosure;

FIG. 3 is a diagram illustrating an example of the drive timing of the pixel circuit shown in FIG. 2;

FIG. 4 is a diagram illustrating an example of a shift register of a gate driver according to an implementation of the present disclosure;

FIG. 5 is a diagram illustrating an example of drive waveforms of the gate driver shown in FIG. 4;

FIG. 6 is a diagram illustrating an example of a configuration of an output circuit according to an implementation of the present disclosure shown in FIG. 4;

FIG. 7 is a diagram illustrating an example of a configuration of a selection circuit shown in FIG. 4;

FIGS. 8A to 8D are diagrams illustrating an example of operation of the selection circuit shown in FIG. 7;

FIGS. 9A to 9B is a diagram illustrating an example of a gate driver according to an implementation of the present disclosure;

FIG. 10 is a diagram illustrating an example of a configuration of an output circuit according to another implementation of the present disclosure shown in FIG. 4;

FIG. 11 is a diagram illustrating an example of a gate driver according to another implementation of the present disclosure;

FIG. 12 is a diagram illustrating an example of the output result of a carry signal according to implementations of the present disclosure; and

FIG. 13 is a diagram illustrating an example of the output result of a gate signal according to implementations of the present disclosure.

### DETAILED DESCRIPTION

A display device, such as a liquid crystal display device or an organic light emitting display device, can include a display panel including sub-pixels, a driver that outputs a driving signal for driving the display panel, a power supply that generates power to be supplied to the display panel or the driver, and the like.

In some scenarios, a display device can be used in a multi-tasking environment, where users may play two or more content images on a single screen of the display device or execute two or more applications to play different images of the applications on the screen. In such a multi-tasking environment, pixels on the display device are typically driven at a single frame frequency.

In some scenarios, gate drivers of display devices can output gate signals sequentially. However, in such scenarios, because there is no separate structure in the gate driver to block the output in the middle region of a frame, it is impractical to drive different areas of the panel at different frequencies.

Implementations of the present disclosure can provide a gate driver capable of driving different areas at different frequencies, and a display device including the same.

According to some implementations of the present disclosure, the gate driver includes a plurality of signal transmission parts, each of which includes two output circuits and one selection circuit. One of the output circuits can output a carry signal, the selection circuit can selectively transmit the carry signal, and the other output circuit can output a gate signal based on the selectively transmitted carry signal. Accordingly, such features can facilitate changing the driving frequency for switching between high-speed and low-speed driving in different areas, and facilitate changing the sizes of the different areas driven by different drive frequencies.

Implementations of the present disclosure can enable response to overlapping outputs of gate signals or changes in output timing.

Implementations of the present disclosure can enable low-speed operation depending on the area and thus low-power operation.

The effects of the present specification are not limited to the above-mentioned effects, and other effects that are not mentioned will be apparently understood by those skilled in the art from the following description and the appended claims.

Advantages and features of the present specification and methods of achieving them will become apparent with reference to preferable implementations, which are described in detail, in conjunction with the accompanying drawings. However, the present specification is not limited to the implementations to be described below and may be implemented in different forms, the implementations are only provided to completely disclose the present disclosure and completely convey the scope of the present disclosure to those skilled in the art, and the present specification is defined by the disclosed claims.

Since the shapes, sizes, proportions, angles, numbers, and the like disclosed in the drawings for describing the implementations of the present disclosure are only examples, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘comprising,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following implementations can be partially or entirely bonded to or combined with each other and can be linked and operated in technically various ways. The implementations can be carried out independently of or in association with each other.

Hereinafter, various implementations of the present disclosure will be described in detail with reference to the accompanying drawings.

In a display device according to implementations of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A gate signal can swing between a gate-on voltage and a gate-off voltage. For example, the gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In an example of an n-channel transistor, a gate-on voltage may be a gate high voltage, and a gate-off voltage may be a gate low voltage. In an example of a p-channel transistor, a gate-on voltage may be a gate low voltage, and a gate-off voltage may be a gate high voltage.

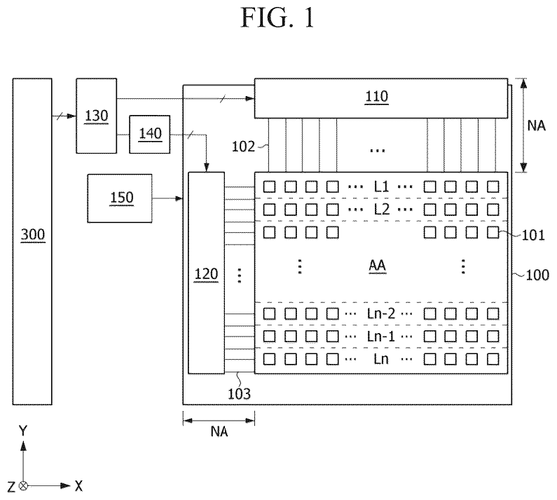

FIG. 1 is a block diagram illustrating an example of a display device according to an implementation of the present disclosure.

Referring to FIG. 1, the display device according to an implementation of the present disclosure includes a display panel 100, and a display panel driving circuit for writing pixel data to pixels 101 of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels 101 arranged in a matrix form. The display panel 100 may further include power lines commonly connected to the pixels 101. The power lines may be commonly connected to pixel circuits to supply a voltage required for driving pixels 101 to the pixels 101.

Each of the pixels 101 may be divided into a red sub-pixel, a green sub-pixel, and a blue sub-pixel for color implementation. Each pixel 101 may further include a white sub-pixel. Each sub-pixel includes a pixel circuit for driving a light emitting element. The light emitting element may include an OLED or an inorganic light emitting diode (LED). Each pixel circuit is connected to the data lines 102, the gate lines 103, and the power lines. In the following description, a pixel 101 may be interpreted as a sub-pixel.

The display area AA includes a plurality of pixel lines L1 to Ln. Each of the pixel lines L1 to Ln includes one line of pixels 101 arranged along the line direction (X-axis direction) in the pixel array of the display panel 100. Those pixels 101 arranged in one pixel line share the gate lines 103. The sub-pixels arranged in the column direction (Y-axis direction) along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 300 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The power supply 150 may further include a gamma voltage generator. The gamma voltage generator receives a high-potential reference voltage and a low-potential reference voltage and outputs a plurality of gamma reference voltages divided at specific intervals on a preset gamma curve, for example, a 2.2 gamma curve. The gamma reference voltages are supplied to the data driver 110. In the data driver 110, the gamma reference voltages are subdivided by a voltage dividing circuit into grayscale voltages. The gamma voltage generator may be implemented with a programmable gamma circuit that may adjust the voltage of each of the gamma reference voltages according to digital data. The timing controller 130, the host system 300, or a separate external device may update digital data stored in a register of the programmable gamma circuit through a communication interface.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. For example, the data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data may include mode selection data for selecting first mode and second mode. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 sequentially outputs pulses of the gate signals to the gate lines 103 under the control of the timing controller 130. The gate driver 120 may sequentially supply the gate signals to the gate lines 103 by shifting the pulses of the gate signals using shift registers. When a plurality of gate signals are applied to each pixel 101, the gate driver 120 may include a plurality of shift registers. The gate signal may include a scan signal being input to the pixel circuit through a plurality of gate lines 103, and an emission signal (or EM signal).

The timing controller 130 receives digital video data of an input image and a timing signal synchronized with this data from the host system 300. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The timing controller 130 may analyze the input image for each frame and generate a control signal for selectively outputting gate signals according to the analysis result. The generated control signal may be provided to the shift register of the gate driver 120 through the level shifter 140.

The host system 300 may include a main board of one of a television system, a set-top box, a navigation system, a personal computer (PC), a vehicle system, a mobile terminal, and a wearable terminal. The host system 300 may scale an image signal from a video source according to the resolution of the display panel 100, and may transmit it to the timing controller 130 together with the timing signals.

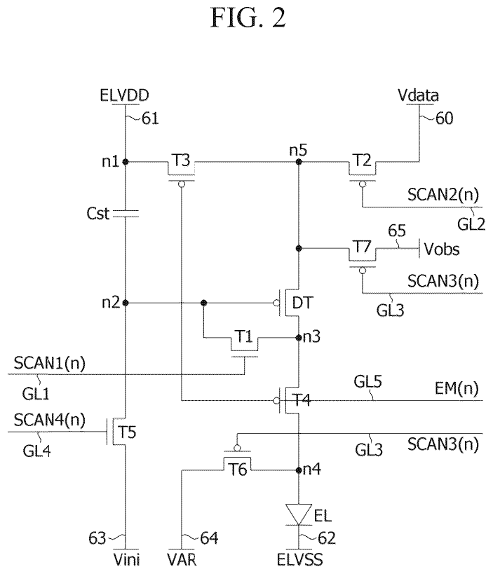

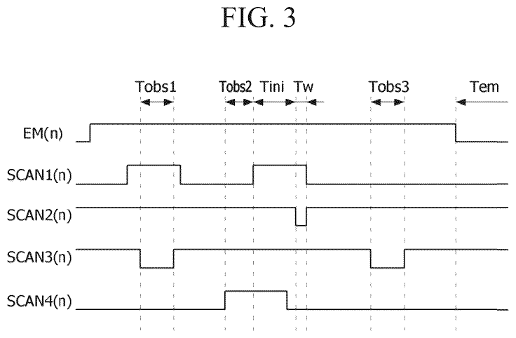

FIG. 2 is a diagram illustrating an example of a pixel circuit according to the implementation of the present disclosure, and FIG. 3 is a diagram illustrating an example of the drive timing of the pixel circuit shown in FIG. 2.

Referring to FIGS. 2 and 3, a pixel circuit according to an implementation of the present disclosure includes a light-emitting element EL, a driving element DT supplying current to the light-emitting element EL, a plurality of switch elements T1, T2, T3, T4, T5, T6, T7 for switching current paths connected to the driving element DT, and a capacitor Cst for storing a gate-to-source voltage of the driving element DT. For example, the driving element DT and the switch elements T2, T3, T4, T6, T7 may be implemented as a P-channel TFT, and the switch elements T1, T5 may be implemented as an N-channel TFT.

The gate signals applied to this pixel circuit include a first scan signal SCAN1(n), a second scan signal SCAN2(n), a third scan signal SCAN3(n), a fourth scan signal SCAN4(n), and an EM signal EM(n). Here n is a natural number.

The capacitor Cst is connected between a first node n1 and a second node n2. A pixel driving voltage ELVDD is supplied to the pixel circuit via an ELVDD wire 61. The first node n1 is connected to an ELVDD wire 61, a first electrode of a third switch element T3, and a first electrode of the capacitor Cst. The second node n2 is connected to a second electrode of the capacitor Cst, a gate electrode of the driving element DT, a first electrode of a first switch element T1, and a first electrode of a fifth switch element T5.

A first switch element T1 is turned on according to a gate-on voltage VEH of the first scan signal SCAN1(n) to connect a gate electrode and a second electrode of the driving element DT. The first switch element T1 includes a gate electrode connected to a first scan line GL1, a first electrode connected to the second node n2, and a second electrode connected to a third node n3. The first scan signal SCAN1(n) is applied to the pixels via the first scan line GL1. The third node n3 is connected to the second electrode of the driving element DT, the second electrode of the first switch element T1, and a first electrode of a fourth switch element T4.

A second switch element T2 is turned on according to a gate-on voltage VEL of the second scan signal SCAN2(n) to apply a data voltage Vdata to a first electrode of the driving element DT. The second switch element T2 includes a gate electrode connected to a second scan line GL2, a first electrode connected to a fifth node n5, and a second electrode connected to a data line 60. The fifth node n5 is connected to the first electrode of the driving element DT, a first electrode of the second switch element T2, and a second electrode of a third switch element T3.

The third switch element T3 supplies the pixel driving voltage ELVDD to the first electrode of the driving element DT in response to the EM signal EM(n). The third switch element T3 includes a gate electrode connected to an EM line GL5, a first electrode connected to the ELVDD wire 61, and a second electrode connected to the fifth node n5. The EM signal EM(n) is fed to the pixels via the EM line GL5.

The fourth switch element T4 is turned on according to a gate-on voltage VEL of the EM signal EM(n) to connect the second electrode of the driving element DT to an anode of the light-emitting element EL. A gate electrode of the fourth switch element T4 is connected to the EM line GL5. A first electrode of the fourth switch element T4 is connected to the third node n3, and a second electrode of the fourth switch element T4 is connected to a fourth node n4. The fourth node n4 is connected to an anode electrode of the light-emitting element EL, the second electrode of the fourth switch element T4, and a second electrode of the sixth switch element T6.

The fifth switch element T5 is turned on according to the gate-on voltage VEH of the fourth scan signal SCAN4(n) to connect the second node n2 to an initialization voltage wire, Vini wire 63, so that the capacitor Cst and the gate of the driving element DT are initialized during an initialization stage Tini. The fifth switch element T5 includes a gate electrode connected to a fourth scan line GL4, a first electrode connected to the second node n2, and a second electrode connected to the Vini wire 63. The fourth scan signal SCAN4(n) is fed to the pixels via the fourth scan line GL4. An initialization voltage Vini is supplied to the pixels via the Vini wire 63.

The sixth switch element T6 is turned on according to a gate-on voltage VEL of the third scan signal SCAN3(n) to connect a VAR wire 64 to the anode electrode of the light-emitting element EL during a first OBS stage Tobs1 and a third OBS stage Tobs3. During the first OBS stage Tobs1 and the third OBS stage Tobs3, an anode voltage of the light-emitting element EL is discharged to a reset voltage VAR through the sixth switch element T6. In this case, the light-emitting element EL does not emit light because a voltage between the anode and the cathode is less than its threshold voltage. The sixth switch element T6 includes a gate electrode connected to a third scan line GL3, the first electrode connected to the VAR wire 64, and the second electrode connected to the fourth node n4.

The seventh switch element T7 is turned on according to a gate-on voltage VEL of the third scan signal SCAN3(n) to apply a bias voltage Vobs by connecting a Vobs wire 65 to the fifth node n5 during the first OBS stage Tobs1 and the third OBS stage Tobs3. During the first OBS stage Tobs1 and the third OBS stage Tobs3, the voltage on the first electrode of the driving element DT is discharged to the bias voltage Vobs via a seventh switch element T7. The seventh switch element T7 includes a gate electrode connected to a third scan line GL3, a first electrode connected to the fifth node n5, and a second electrode connected to a Vobs wire 65.

The driving element DT drives the light-emitting element EL by regulating a current flowing to the light-emitting element EL according to a gate-source voltage Vgs. The driving element DT includes the gate electrode connected to the second node n2, the first electrode connected to the fifth node n5, and the second electrode connected to the third node n3.

The light-emitting element EL is connected between the fourth node n4 and an ELVSS wire 62. The light-emitting element EL may be implemented as an OLED. The OLED includes an organic compound layer formed between an anode and a cathode. The organic compound layer may include, but is not limited to, a hole injection layer HIL, a hole transport layer HTL, an emission layer EML, an electron transport layer ETL, and an electron injection layer EIL. When a voltage is applied to the anode and the cathode of the OLED, holes passing through the electron transport layer HTL and electrons passing through the electron transport layer ETL move to the emission layer EML to form excitons, thereby causing visible light to be emitted from the emission layer EML.

In the first OBS stage Tobs1, the seventh switch element T7 is turned on, discharging a voltage of the fifth node n5 to the bias voltage Vobs.

In the second OBS stage Tobs2, the fifth switch element T5 is turned on, discharging a voltage of the second node n2 to the initialization voltage Vini.

In an initialization stage Tini, the first switch element T1 and the fifth switch element T5 are turned on, discharging voltages of the second node n2 and the third node n3 to the initialization voltage Vini.

In a data writing stage Tw, the second switch element T2 is turned on, so that the data voltage is applied to the fifth node n5 and the voltage of the second node n2 becomes a voltage of Vdata+Vth. A threshold voltage Vth of the driving element DT is sensed and charged to the capacitor Cst connected to the second node n2.

In the third OBS stage Tobs3, the seventh switch element T7 is turned on, discharging the voltage of the fifth node n5 to the bias voltage Vobs.

In a light emission stage Tem, the third switch element T3 and the fourth switch element T4 are turned on, so that a current flows through the driving element DT to the light-emitting element EL to emit the light-emitting element EL.

A “frame skip” can be performed by not outputting the gate signal. This can be implemented by not outputting the first scan signal and the fourth scan signal among the five signals, namely the first to fourth scan signals and the EM signal, to the pixel circuit of FIG. 2. For example, during the frame skipping, the first switch element T1 and the fifth switch element T5 may be turned off so that the voltages of the second node n2 and the third node n3 are not initialized.

In an implementation of the present disclosure, the gate driver includes a plurality of signal transmission parts. Each signal transmission part can include, for example, two output circuits and one selection circuit. One of the output circuits can output a carry signal, the selection circuit can selectively transmit the carry signal, and the other output circuit can output a gate signal based on the selectively transmitted carry signal.

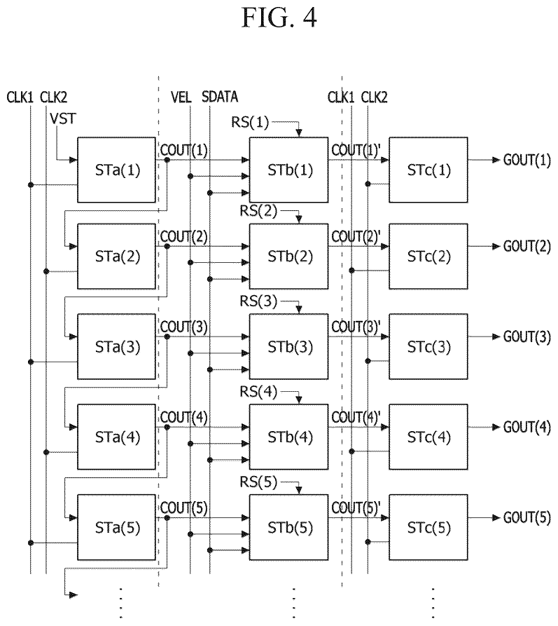

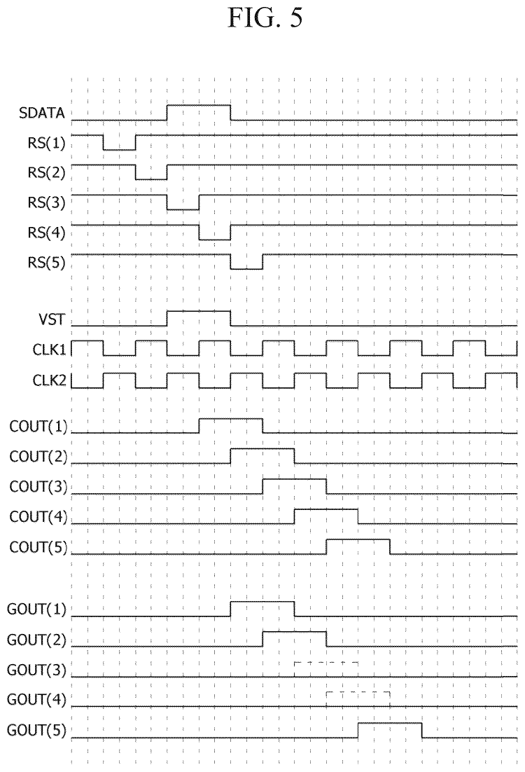

FIG. 4 is a diagram illustrating an example of a shift register of a gate driver according to an implementation of the present disclosure, and FIG. 5 is a diagram illustrating an example of drive waveforms of the gate driver shown in FIG. 4.

Referring to FIGS. 4 and 5, the gate driver according to the implementation includes a plurality of signal transmission parts. For example, FIG. 4 illustrates a first signal transmission part (STa(1), STb(1), STc(1)), a second signal transmission part (STa(2), STb(2), STc(2)), a third signal transmission part (STa(3), STb(3), STc(3)), a fourth signal transmission part (STa(4), STb(4), STc(4)), and a fifth signal transmission part (STa(5), STb(5), STc(5)), . . . , that are connected in cascade via carry lines through which carry signals are transmitted. STa and STc represent the output circuits, and STb represents the selection circuit.

In the implementation, a pair of the output circuits STa(n) and STc(n) in each signal transmission part may be implemented as the same circuit, but are not necessarily limited thereto, and may be implemented as different circuits.

Each of the first output circuits STa(1), STa(2), STa(3), STa(4), STa(5), . . . in each signal transmission part either receives a start signal VST (e.g., as in STa(1)) or receives a carry signal that is output from a preceding signal transmission part (e.g., as in STa(2), STa(3), . . . ), and a clock signal. The first output circuit STa(1) starts to drive according to the start signal VST, and each of the other first output circuits STa(2), STa(3), STa(4), STa(5), . . . starts to drive by receiving a carry signal COUT(1), COUT(2), COUT(3), COUT(4), COUT(5), . . . from the preceding signal transmission part.

Each of the selection circuits STb(1), STb(2), STb(3), STb(4), STb(5), . . . in each signal transmission part can either transmit the carry signal output from the first output circuit (i.e., STa(1), STa(2), STa(3), STa(4), STa(5), . . . respectively) without modification, or can transmit an off signal instead of the carry signal, depending on a selection signal.

Each of the other second output circuits STc(1), STc(2), STc(3), STc(4), STc(5), . . . in each signal transmission part may shift a carry signal COUT(1)′, COUT(2)′, COUT(3)′, COUT(4)′, COUT(5)′, . . . output from the selection circuit in accordance with the timing of a clock signal, and sequentially output gate signals GOUT(1), GOUT(2), GOUT(3), GOUT(4), GOUT(5), . . . , respectively.

In this case, as shown in FIG. 5, even though the signal transmission part, at which a frame skip period starts, blocks the transmission of a carry signal at a timing of outputting a gate signal so as not to output the gate signal, the carry signal continues to be output. For example, FIG. 5 shows the outputs GOUT(3) and GOUT(4) of the second output circuits STc(3) and STc(4) are blocked and the output GOUT(5) of the second output circuit STc(5) is resumed. In this case, even though the second output circuits STc(3) and STc(4) do not output gate signals (i.e., GOUT(3) and GOUT(4) are not output), the carry signals COUT(3) and COUT(4) are still continuously output from the first output circuits STa(3) and STa(4).

Accordingly, based on the selection signal and a selection data voltage, the second output circuit STc(5) may receive the carry signal from the first output circuit STa(5), and may thus resume outputting the gate signal.

As such, in the present implementation, by applying a high voltage level of the selection data voltage and the selection signal only to a user-desired area, transmission of the carry signal may be blocked, thereby blocking the output of the gate signal in those user-desired area. And, by applying a low voltage level of the selection data voltage and the selection signal to other areas, the carry signal may be transmitted, thereby resuming the output of the gate signal in those other areas.

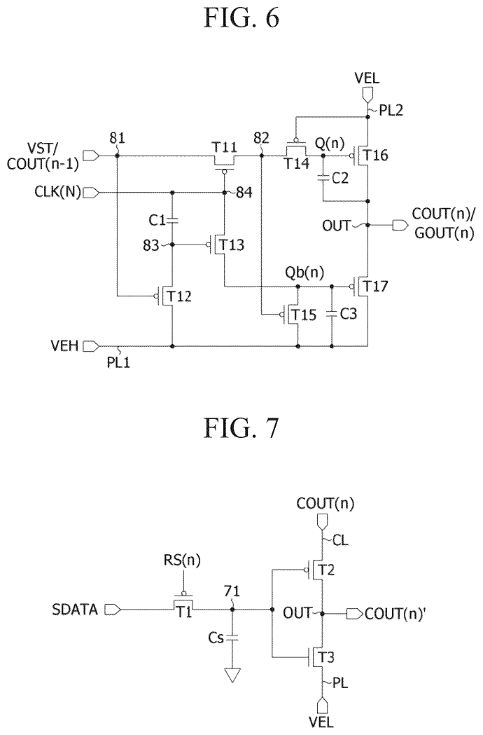

FIG. 6 is a diagram illustrating an example of a configuration of an output circuit, e.g., one of the first and second output circuits STa(n) and STc(n) shown in FIG. 4, according to an implementation of the present disclosure.

Referring to FIG. 6, an output circuit according to an implementation of the present disclosure may include an eleventh transistor T11, a twelfth transistor T12, a thirteenth transistor T13, a fourteenth transistor T14, a fifteenth transistor T15, a sixteenth transistor T16 which can be a pull-up transistor, a seventeenth transistor T17 which can be a pull-down transistor, an eleventh capacitor C1, a twelfth capacitor C2, and a thirteenth capacitor C3. The output circuit of FIG. 6 can implement, but is not limited to, a first output circuit STa(n) and a second output circuit STc(n), which may be implemented in the same circuit.

The eleventh transistor T11 is turned on according to a clock signal CLK(N) and connects a first node 81 to a second node 82. The eleventh transistor T11 includes a gate electrode connected to a fourth node 84 to which the clock signal CLK(N) is applied, a first electrode connected to the first node 81, and a second electrode connected to the second node 82.

The twelfth transistor T12 is turned on according to the start signal VST or a preceding carry signal COUT(n−1), and connects a third node 83 to a first power line PL1 to which a high potential voltage VEH is applied. The twelfth transistor T12 includes a gate electrode connected to the first node 81, a first electrode connected to the third node 83, and a second electrode connected to the first power line PL1.

The thirteenth transistor T13 is turned on by a voltage from the third node 83 and connects the fourth node 84 to a second control node Qb(n). The thirteenth transistor T13 includes a gate electrode connected to the third node 83, a first electrode connected to the fourth node 84, and a second electrode connected to the second control node Qb(n).

The fourteenth transistor T14 is turned on by a low potential voltage VEL and connects the second node 82 to the first control node Q(n). The fourteenth transistor T14 includes a gate electrode connected to the second power line PL2 to which the low potential voltage VEL is applied, a first electrode connected to the second node 82, and a second electrode connected to the first control node Q(n).

The fifteenth transistor T15 is turned on by the voltage from the second node 82 and connects the first power line PL1 to the second control node Qb(n). The fifteenth transistor T15 includes a gate electrode connected to the second node 82, a first electrode connected to the second control node Qb(n), and a second electrode connected to the first power line PL1.

The sixteenth transistor T16 is turned on by a voltage from the first control node Q(n) and outputs the low potential voltage VEL as the gate signal GOUT to an output node OUT. The sixteenth transistor T16 includes a gate electrode connected to the first control node Q(n), a first electrode connected to the second power line PL2, and a second electrode connected to the output node OUT.

The seventeenth transistor T17 is turned on by a voltage from the second control node Qb(n) and outputs the high potential voltage VEH as the gate signal GOUT to the output node OUT. The seventeenth transistor T17 includes a gate electrode connected to the second control node Qb(n), a first electrode connected to the output node OUT, and a second electrode connected to the first power line PL1.

The eleventh capacitor C1 is connected between the third node 83 and the fourth node 84. The twelfth capacitor C2 is connected between the gate electrode and the second electrode of the sixteenth transistor T16. The thirteen capacitor C3 is connected between the gate electrode and the second electrode of the seventeenth transistor T17.

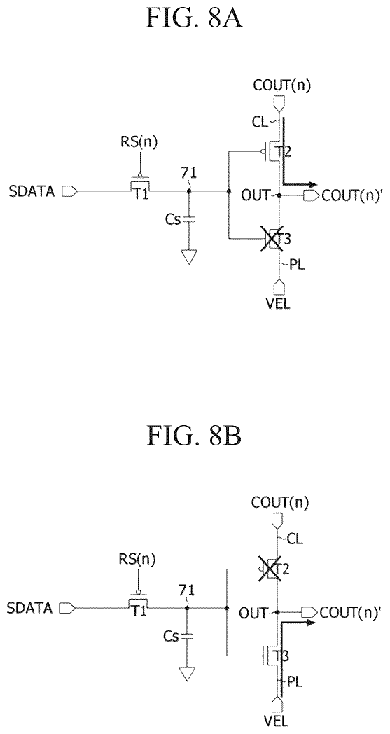

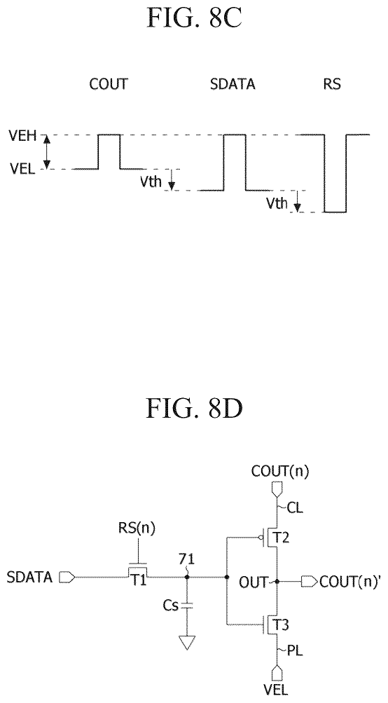

FIG. 7 is a diagram illustrating an example of a configuration of the selection circuit, e.g., one of the selection circuits STb(n) shown in FIG. 4, and FIGS. 8A to 8D are diagrams illustrating examples of the principle of operation of the selection circuit shown in FIG. 7.

Referring to FIG. 7, a selection circuit according to an implementation of the present disclosure may include a first transistor T1, a second transistor T2, a third transistor T3, and a capacitor Cs.

The first transistor T1 is turned on by the selection signal RS(n) and supplies the selection data voltage SDATA to a first node 71. The first transistor T1 includes a gate electrode to which the selection signal RS(n) is applied, a first electrode to which the selection data voltage SDATA is applied, and a second electrode connected to the first node 71.

The first transistor T1 may be implemented as a P-channel TFT, but is not limited thereto. For example, if the first transistor T1 is implemented as a P-channel TFT, the selection signal RS(n) may be a signal generated from a timing controller or generated from a separately configured circuit.

The second transistor T2 is turned on by the voltage at the first node 71 so that the carry signal COUT(n) from the first output circuit is output as a carry signal COUT(n)′ to an output node OUT. The second transistor T2 includes a gate electrode connected to the first node 71, a first electrode connected to a carry line CL to which the carry signal COUT(n) from the first output circuit is applied, and a second electrode connected to the output node OUT.

The third transistor T3 is turned on by the voltage at the first node 71 so that the low potential voltage VEL is output as the carry signal COUT(n)′ to the output node OUT. The third transistor T3 includes a gate electrode connected to the first node 71, a first electrode connected to the output node OUT, and a second electrode connected to a power line PL to which the low potential voltage VEL is applied.

In this case, the second transistor T2 may be implemented as a P-channel TFT and the third transistor T3 may be implemented as an N-channel TFT, but is not limited thereto.

The capacitor Cs is connected between the first node 71 and ground. The capacitor Cs is capable of stably storing the selection data voltage applied to the first node 71.

Referring to FIG. 8A, when the first transistor T1 is turned on by the selection signal RS(n), the selection data voltage SDATA may be stored in the first node 71. In this case, if the selection data voltage SDATA is a low level voltage, the second transistor T2 (implemented as a P-channel TFT in this example) may be turned on and the third transistor T3 (implemented as an N-channel TFT in this example) may be turned off so that the carry signal COUT(n) from the first output circuit may be output as the carry signal COUT(n)′ via the output node OUT.

Referring to FIG. 8B, when the first transistor T1 is turned on by the selection signal RS(n), the selection data voltage SDATA may be stored in the first node 71. In this case, if the selection data voltage SDATA is a high level voltage, the second transistor T2 (P-channel TFT) may be turned off and the third transistor T3 (N-channel TFT) may be turned on so that the low potential voltage VEL may be output as the carry signal COUT(n)′ through the output node OUT. That is, the carry signal COUT(n) from the first output circuit may be blocked and the low potential voltage VEL may be output as the carry signal COUT(n)′ from the selection circuit.

As such, in an area where the frequency is to be changed, the carry signal COUT(n) from the first output circuit may be blocked by applying the high voltage level selection data voltage SDATA to the selection circuit in the signal transmission part that is connected to the pixel line in the area where the frequency is to be changed.

Referring to FIG. 8C, the high voltage levels of the selection signal RS(n) and the selection data voltage SDATA are the same as the high potential voltage VEH, but the low voltage levels may be formed differently. This is because, for example, in order for the second transistor T2, which is a P-channel TFT, to turn on, the low voltage level of the selection data voltage SDATA must be formed lower than carry signal COUT(n), which can be as low as the low potential voltage VEL, by a magnitude of the threshold voltage Vth=−3V. Further, in order for the first transistor T1, which is a P-channel TFT, to turn on, the low voltage level of the selection signal RS(n) must be formed lower than the low voltage level of the selection data voltage SDATA by a magnitude of the threshold voltage Vth=−3V.

In other words, if the threshold voltage Vth of the P-channel TFT is −3V, the gate-on voltage must be lower than the low potential voltage VEL-|Vth|. However, since the low voltage level of the signal generated from the gate driver is the low potential voltage VEL, the selection signal RS(n) may be generated from the timing controller rather than from the gate driver when the first transistor T1 is implemented as a P-channel TFT.

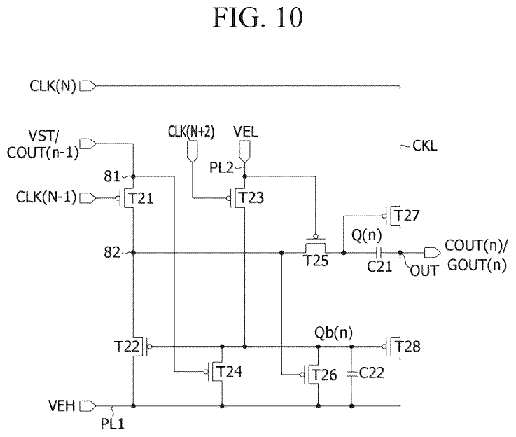

On the other hand, when the first transistor T1 is implemented as an N-channel TFT as shown in FIG. 8D, the gate-on voltage is the high potential voltage VEH, so the selection signal RS(n) may be generated from the gate driver or generated from the timing controller. In this case, the circuit of the gate driver generating the selection signal RS may have the same configuration as an output circuit shown in FIG. 10.

Therefore, as shown in FIG. 8A, when the selection data voltage SDATA is at the low voltage level, the second transistor T2 (P-channel) is turned on, and when the selection data voltage SDATA is at the high voltage level, the second transistor T2 is turned off because the selection data voltage SDATA is equal to the high potential voltage VEH which is the gate-on voltage.

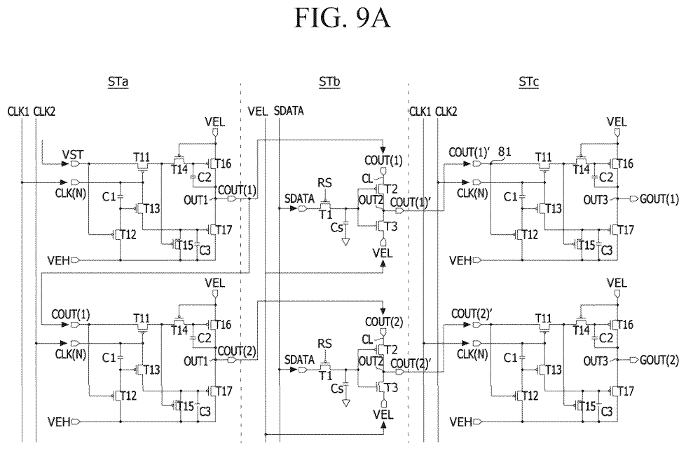

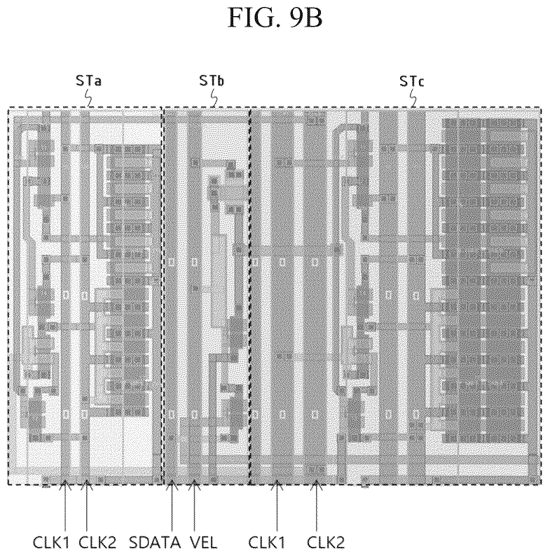

FIGS. 9A to 9B are diagrams illustrating examples of a gate driver according to an implementation of the present disclosure. FIG. 9A shows an example of the circuit of a gate driver, and FIG. 9B shows an example of the panel layout of the gate driver.

Referring to FIGS. 9A and 9B, the gate driver according to the implementation of the present disclosure may include a first output circuit STa, a selection circuit STb, and a second output circuit STc.

FIG. 9A shows only the first two signal transmission parts, each with respective circuits STa, STb, STc, but similar description can apply to subsequent signal transmission parts. The first output circuit STa may output a high voltage level carry signal COUT(n) based on the start signal VST and clock signals CLK1 and CLK2. The first output circuit STa may output the high voltage level carry signal COUT(n) which is applied to both the selection circuit STb, and also to the first output circuit STa of the next signal transmission part.

For this purpose, the output node OUT1 of the first output circuit STa may be connected to a carry line CL of the selection circuit STb.

The selection circuit STb may output or block the carry signal COUT(n) from the first output circuit STa based on the selection signal RS and the selection data voltage SDATA. For example, the selection circuit STb may output the high voltage level carry signal COUT(n) from the first output circuit as the carry signal COUT(n)′ transmitted to the second output circuit STc, when the selection signal RS and the low voltage level selection data voltage SDATA are applied.

On the other hand, the selection circuit STb may transmit a low level voltage carry signal COUT(n)′ to the second output circuit STc, without outputting the high voltage level carry signal COUT(n) from the first output circuit, when the selection signal RS and the selection data voltage SDATA of the high voltage level are applied.

For this purpose, the output node OUT2 of the selection circuit STb may be connected to the first node 81 of the second output circuit STc.

The second output circuit STc may output a gate signal GOUT(n) based on the clock signals CLK1 and CLK2 and the high voltage level carry signal COUT(n)′. The second output circuit STc outputs the gate signal GOUT(n) when it receives the carry signal COUT(n)′ from the selection circuit STb, but does not output the gate signal when it does not receive the carry signal.

FIG. 10 is a diagram illustrating an example of a configuration of an output circuit according to another implementation of the present disclosure shown in FIG. 4.

Referring to FIG. 10, an output circuit according to another implementation of the present disclosure may include a twenty-first transistor T21, a twenty-second transistor T22, a twenty-third transistor T23, a twenty-fourth transistor T24, a twenty-fifth transistor T25, a twenty-sixth transistor T26, a twenty-seventh transistor or pull-up transistor T27, a twenty-eighth transistor or pull-down transistor T28, a twenty-first capacitor C21, and a twenty-second capacitor C22. The output circuit of FIG. 10 can implement, but is not limited to, a first output circuit STa(n) and a second output circuit STc(n), which may be implemented in the same circuit.

The twenty-first transistor T21 is turned on according to a preceding clock signal CLK(N−1) and connects a first node 81 to a second node 82. The twenty-first transistor T21 includes a gate electrode to which the preceding clock signal CLK(N−1) is applied, a first electrode connected to the first node 81, and a second electrode connected to the second node 82.

The twenty-second transistor T22 is turned on by a voltage of the second control node Qb(n) and connects the second node 82 to the first power line PL1 to which a high potential voltage VEH is applied. The twenty-second transistor T22 includes a gate electrode connected to the second control node Qb(n), a first electrode connected to the second node 82, and a second electrode connected to the first power line PL1.

The twenty-third transistor T23 is turned on by a next clock signal CLK(N+2) and connects the second control node Qb(n) to the second power line PL2 to which a low potential voltage VEL is applied. The twenty-third transistor T23 includes a gate electrode to which the next clock signal CLK(N+2) is applied, a first electrode connected to the second power line PL2, and a second electrode connected to the second control node Qb(n).

The twenty-fourth transistor T24 is turned on by the voltage of the first node 81 and connects the first power line PL1 to the second control node Qb(n). The twenty-fourth transistor T24 includes a gate electrode connected to the first node 81, a first electrode connected to the second control node Qb(n), and a second electrode connected to the first power line PL1.

The twenty-fifth transistor T25 is turned on by the low potential voltage VEL and connects the second node 82 to the first control node Q(n). The twenty-fifth transistor T25 includes a gate electrode connected to the second power line PL2, a first electrode connected to the second node 82, and a second electrode connected to the first control node Q(n).

The twenty-sixth transistor T26 is turned on by the voltage of the second node 82 and connects the second control node Qb(n) to the first power line PL1. The twenty-sixth transistor T26 includes a gate electrode connected to the second node 82, a first electrode connected to the second control node Qb(n), and a second electrode connected to the first power line PL1.

The twenty-seventh transistor T27 is turned on by a voltage of the first control node Q(n) and outputs the low potential voltage VEL to an output node OUT. The twenty-seventh transistor T27 includes a gate electrode connected to the first control node Q(n), a first electrode connected to a clock line CKL to which the clock signal CLK(N) is applied, and a second electrode connected to the output node OUT.

The twenty-eighth transistor T28 is turned on by a voltage of the second control node Qb(n) and outputs the high potential voltage VEH to the output node OUT. The twenty-eighth transistor T28 includes a gate electrode connected to the second control node Qb(n), a first electrode connected to the output node OUT, and a second electrode connected to the first power line PL1.

A twenty-first capacitor C21 is connected between the gate electrode and the second electrode of the twenty-seventh transistor T27. A twenty-second capacitor C22 is connected between the gate electrode and the second electrode of the twenty-eighth transistor T28.

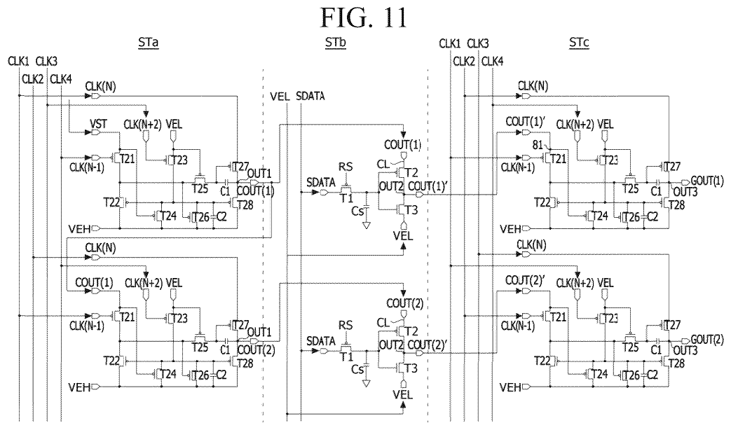

FIG. 11 is a diagram illustrating an example of a gate driver according to another implementation of the present disclosure.

Referring to FIG. 11, a gate driver according to another implementation of the present disclosure may include a first output circuit (STa), a selection circuit (STb), and a second output circuit (STc).

The first output circuit STa may output, as a high voltage level carry signal COUT(n), the high voltage level clock signals CLK1 to CLK4 based on the start signal VST and the clock signals CLK1 to CLK4. The first output circuit STa may apply the high voltage level carry signal COUT(n) both to the selection circuit STb, and also to the first output circuit STa of the next signal transmission part.

For this purpose, the output node OUT1 of the first output circuit STa may be connected to a carry line CL of the selection circuit STb.

The selection circuit STb may transmit or block a carry signal COUT(n) from the first output circuit STa, based on the selection signal RS and the selection data voltage SDATA. The selection circuit STb may output the high voltage level carry signal COUT(n) from the first output circuit STa as the carry signal COUT(n)′ transmitted to the second output circuit STc when the selection signal RS and the low voltage level selection data voltage SDATA are applied.

On the other hand, the selection circuit STb may transmit a low level voltage carry signal COUT(n)′ to the second output circuit STc, without outputting the high voltage level carry signal COUT(n) from the first output circuit STa, when the selection signal RS and the selection data voltage SDATA of the high voltage level are applied.

For this purpose, the output node OUT2 of the selection circuit STb may be connected to the first node 81 of the second output circuit STc.

The second output circuit STc may output, as a high voltage level gate signal GOUT(n), a high voltage level clock signals CLK1 to CLK4 based on the clock signals CLK1 to CLK4 and the high voltage level carry signal COUT(n)′. The second output circuit STc outputs the gate signal GOUT(n) when it receives the carry signal COUT(n)′ from the selection circuit STb, but does not output the gate signal GOUT(n) when it does not receive the carry signal COUT(n)′.

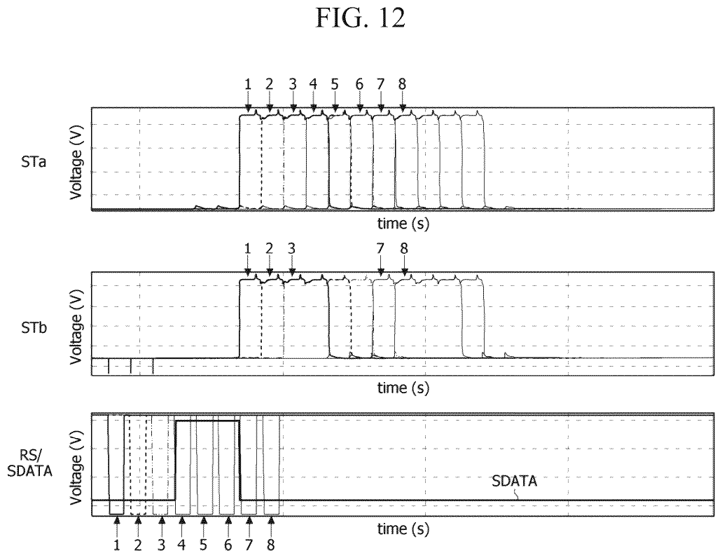

FIG. 12 is a diagram illustrating an example of the output result of a carry signal according to implementations of the present disclosure.

Referring to FIG. 12, each of the first output circuits STa in the eight signal transmission parts may output the respective carry signal COUT(1), COUT(2), COUT(3), COUT(4), COUT(5), COUT(6), COUT(7), COUT(8).

The selection circuits STb in the eight signal transmission parts may selectively transmit carry signals COUT(1), COUT(2), COUT(3), COUT(7), COUT(8), which are some of the carry signals output from the first output circuits STa, based on the selection signal RS and the selection data voltage SDATA. In other words, the selection circuit STb may receive the selection data voltage SDATA by the selection signal RS and selectively transmit the carry signal based on the voltage level of the received selection data voltage SDATA.

For example, the selection circuit STb may output the carry signal when the selection data voltage SDATA is at the low voltage level, but may not output the carry signal when the selection data voltage SDATA is at the high voltage level. Here, outputting the carry signal means outputting the carry signal of the gate-on voltage, while not outputting the carry signal means outputting the carry signal of the gate-off voltage.

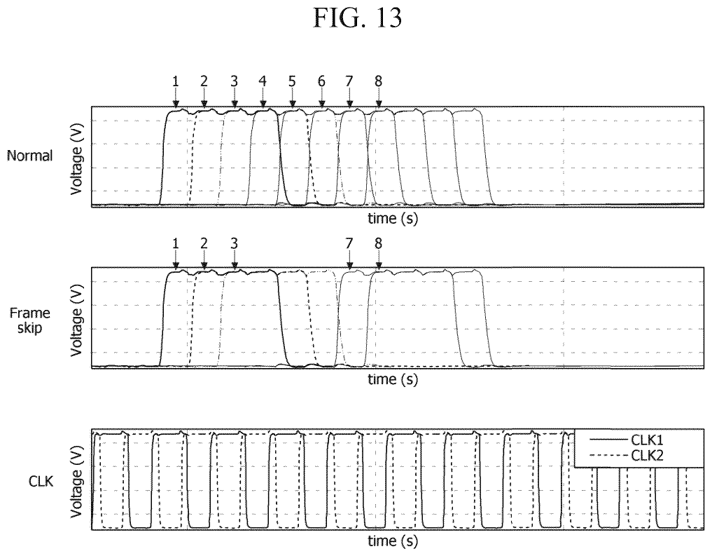

FIG. 13 is a diagram illustrating an example of the output result of a gate signal according to implementations of the present disclosure.

Referring to FIG. 13, during normal operation, each of the eight signal transmission parts may output the respective output gate signal GOUT(1), GOUT(2), GOUT(3), GOUT(4), GOUT(5), GOUT(6), GOUT(7), and GOUT(8) according to the timing of the clock signal CLK.

During frame skip operation, among the eight signal transmission parts that output their respective gate signals in accordance with the timing of the clock signal CLK, only the signal transmission parts that selectively receive the carry signal may output their respective gate signals GOUT(1), GOUT(2), GOUT(3), GOUT(7), GOUT(8).

In this way, in the implementation, gate signals may be selectively output on a pixel line basis.

Although the implementations of the present disclosure have been described in more detail with reference to the accompanying drawings, the present disclosure is not limited thereto and may be embodied in many different forms without departing from the technical concept of the present disclosure. Therefore, the implementations disclosed in the present disclosure are provided for illustrative purposes only and are not intended to limit the technical concept of the present disclosure. The scope of the technical concept of the present disclosure is not limited thereto. Therefore, it should be understood that the above-described implementations are illustrative in all aspects and do not limit the present disclosure.

What is claimed is:

1. A gate driver comprising:
a plurality of signal transmission parts that are connected in cascade via carry lines configured to apply respective carry signals as inputs to the plurality of signal transmission parts,
wherein each signal transmission part of the plurality of signal transmission parts includes:
a first output circuit configured to receive a first carry signal from a preceding signal transmission part and output a second carry signal based on the first carry signal and a clock signal;
a selection circuit configured to receive the second carry signal from the first output circuit and selectively output the second carry signal based on a voltage level of a selection data voltage; and
a second output circuit configured to output a gate signal based on (i) the selectively transmitted second carry signal from the selection circuit and (ii) another clock signal.

2. The gate driver according to claim 1, wherein the selection circuit is configured to
output the second carry signal based on the voltage level of the selection data voltage applied as a gate-on voltage level, and
not output the second carry signal based on the voltage level of the selection data voltage applied as a gate-off voltage level.

3. The gate driver according to claim 1, wherein the selection circuit includes:
a first transistor including a gate electrode to which a selection signal is applied, a first electrode to which the selection data voltage is applied, and a second electrode connected to a first node;
a second transistor including a gate electrode connected to the first node, a first electrode to which the second carry signal is applied, and a second electrode connected to an output node; and
a third transistor including a gate electrode connected to the first node, a first electrode connected to the output node, and a second electrode to which a low potential voltage is applied.

4. The gate driver according to claim 3, wherein the second transistor is an N-channel transistor and the third transistor is a P-channel transistor, or, the second transistor is the P-channel transistor and the third transistor is the N-channel transistor.

5. The gate driver according to claim 3, further comprising a capacitor connected between the first node and a ground.

6. The gate driver according to claim 5, wherein the selection circuit is configured such that,
based on the first transistor turned on by the selection signal, the selection data voltage is stored in the capacitor, and
based on the second transistor turned on by the selection data voltage stored in the capacitor, the second carry signal is output through the output node.

7. The gate driver according to claim 6, wherein the selection circuit is configured such that,
based on the third transistor turned on by the selection data voltage stored in the capacitor, the low potential voltage is output through the output node.

8. The gate driver according to claim 1, wherein the first output circuit and the second output circuit each include a pull-up transistor and a pull-down transistor,
wherein the pull-up transistor includes a gate electrode connected to a first control node, a first electrode connected to a low potential voltage, and a second electrode connected to an output node, and
wherein the pull-down transistor includes a gate electrode connected to a second control node, a first electrode connected to the output node, and a second electrode connected to a high potential voltage.

9. The gate driver according to claim 1, wherein the first output circuit and the second output circuit each include a pull-up transistor and a pull-down transistor,
wherein the pull-up transistor includes a gate electrode connected to a first control node, a first electrode to which the clock signal or the another clock signal is applied, and a second electrode connected to an output node, and
wherein the pull-down transistor includes a gate electrode connected to a second control node, a first electrode connected to the output node, and a second electrode to which a high potential voltage is applied.

10. A display device comprising:
a pixel array in which a plurality of data lines, a plurality of gate lines, and a plurality of pixel circuits are arranged;
a data driver configured to output a data voltage to the plurality of data lines; and
a gate driver configured to output a gate signal to the plurality of gate lines,
wherein the gate driver includes a plurality of signal transmission parts that are connected in cascade via carry lines configured to apply respective carry signals as inputs to the plurality of signal transmission parts,
wherein each signal transmission part of the plurality of signal transmission parts includes:
a first output circuit configured to receive a first carry signal from a preceding signal transmission part and output a second carry signal based on the first carry signal and a clock signal;
a selection circuit configured to receive the second carry signal from the first output circuit and selectively output the second carry signal based on a voltage level of a selection data voltage; and
a second output circuit configured to output a gate signal based on (i) the selectively transmitted second carry signal from the selection circuit and (ii) another clock signal.

11. The display device according to claim 10, wherein the selection circuit is configured to
output the second carry signal based on the voltage level of the selection data voltage applied as a gate-on voltage level, and
not output the second carry signal based on the voltage level of the selection data voltage applied as a gate-off voltage level.

12. The display device according to claim 10, wherein the selection circuit includes:
a first transistor including a gate electrode to which a selection signal is applied, a first electrode to which the selection data voltage is applied, and a second electrode connected to a first node;
a second transistor including a gate electrode connected to the first node, a first electrode to which the second carry signal is applied, and a second electrode connected to an output node; and
a third transistor including a gate electrode connected to the first node, a first electrode connected to the output node, and a second electrode to which a low potential voltage is applied.

13. The display device according to claim 12, wherein the second transistor is an N-channel transistor and the third transistor is a P-channel transistor, or, the second transistor is the P-channel transistor and the third transistor is the N-channel transistor.

14. The display device according to claim 12, further comprising a capacitor connected between the first node and a ground.

15. The display device according to claim 14, wherein the selection circuit is configured such that,
based on the first transistor turned on by the selection signal, the selection data voltage is stored in the capacitor, and
based on the second transistor turned on by the selection data voltage stored in the capacitor, the second carry signal is output through the output node.

16. The display device according to claim 15, wherein the selection is configured such that,
based on the third transistor turned on by the selection data voltage stored in the capacitor, the low potential voltage is output through the output node.

17. The display device according to claim 12, further comprising a timing controller configured to control operation timing of the data driver and the gate driver,
wherein the selection signal is a signal generated by the timing controller or generated by the gate driver.

18. The display device according to claim 10, wherein the first output circuit and the second output circuit each include a pull-up transistor and a pull-down transistor,
wherein the pull-up transistor includes a gate electrode connected to a first control node, a first electrode connected to a low potential voltage, and a second electrode connected to an output node, and
wherein the pull-down transistor includes a gate electrode connected to a second control node, a first electrode connected to the output node, and a second electrode connected to a high potential voltage.

19. The display device according to claim 10, wherein the first output circuit and the second output circuit each include a pull-up transistor and a pull-down transistor,
wherein the pull-up transistor includes a gate electrode connected to a first control node, a first electrode to which the clock signal or the another clock signal is applied, and a second electrode connected to an output node, and
wherein the pull-down transistor includes a gate electrode connected to a second control node, a first electrode connected to the output node, and a second electrode to which a high potential voltage is applied.

20. A display device comprising:
a pixel array comprising a plurality of pixel circuits connected to a plurality of data lines and to a plurality of gate lines; and
a plurality of signal transmission parts configured to output a plurality of gate signals to the plurality of gate lines,
wherein the plurality of signal transmission parts includes a first signal transmission part and a second signal transmission part,
wherein the first signal transmission part comprises:
(i) a first output circuit configured to receive a first input signal and output a first carry signal based on the first input signal and a first clock signal;
(ii) a first selection circuit configured to receive the first carry signal and output a second carry signal based on the first carry signal and a voltage level of a selection data voltage; and
(iii) a second output circuit configured to receive the second carry signal and output a first gate signal based on the second carry signal and a second clock signal, and
wherein the second signal transmission part comprises:
(i) a third output circuit configured to receive the first carry signal from the first output circuit of the first signal transmission part, and output a third carry signal based on the first carry signal and the second clock signal;
(ii) a second selection circuit configured to receive the third carry signal and output a fourth carry signal based on the third carry signal and the voltage level of the selection data voltage; and
(iii) a fourth output circuit configured to receive the fourth carry signal and output a second gate signal based on the fourth carry signal and the first clock signal.
